(19) United States
(12) Patent Application Publication
(10) Pub. No.: US 2023/0322269 A1
(43) Pub. Date: Oct. 12, 2023

(54) Method and Device for Planning a Future Trajectory of an Autonomously or Semi-Autonomously Driving Vehicle

(71) Applicant: Volkswagen Aktiengesellschaft, Wolfsburg (DE)

(72) Inventor: Kristof Van Ende, Braunschweig (DE)

(73) Assignee: Volkswagen Aktiengesellschaft, Wolfsburg (DE)

(21) Appl. No.: 18/044,095

(22) PCT Filed: Aug. 4, 2021
(86) PCT No.: PCT/EP2021/071723

§ 371 Date: Mar. 6, 2023

(30) Foreign Application Priority Data
Sep. 6, 2020 (DE) 10 2020 211 186.3

(51) Int. Cl. B60W 60/00

(52) U.S. Cl. CPC B60W 60/0027; B60W 2554/4046; B60W 2556/45; B60W 2554/402; B60W 2554/20

(57) ABSTRACT

The disclosure relates to a method for planning a future trajectory of an autonomously or semi-autonomously driving vehicle, wherein sensor data are detected by means of at least one sensor of the vehicle, wherein an optimum trajectory for the vehicle is determined for an environmental status derived from the detected sensor data, wherein possible future trajectories of the vehicle are generated to this end and evaluated by means of a reward function, wherein in so doing, a behavior of the vehicle, a static environment and a behavior of other road users are taken into consideration, wherein an influence exerted by the behavior of the vehicle on the other road users is additionally taken into consideration in the reward function, and wherein the determined optimum trajectory is provided for execution.

### CROSS-REFERENCE TO RELATED APPLICATIONS

This application claims priority to German Patent Application No. DE 10 2020 211 186.3, filed on Sep. 6, 2020 with the German Patent and Trademark Office. The contents of the aforesaid Patent Application are incorporated herein for all purposes.

### TECHNICAL FIELD

The invention relates to a method and a device for planning a future trajectory of an autonomously or semi-autonomously driving vehicle. The invention further relates to a vehicle.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Future assisted and autonomous automated driving functions are becoming increasingly more comprehensive and must master ever more complex driving situations. In a number of complex driving situations, an interaction with other road users is needed on the one hand to satisfy safety-relevant requirements as well as, on the other hand, to bring about human-like driving behavior and thereby achieve greater acceptance in society. This sometimes social interaction with the other road users (such as merging onto the highway, the zipper method, traffic circles, etc.) has previously been insufficiently taken into account in maneuvering and trajectory planning.

Known solutions for planning maneuvering and trajectories are mostly based on the fact that other road users are assigned movement models that are taken into account in the calculation of an optimum trajectory. A sum of the costs caused by one's own trajectory and the trajectory of the other traffic road users then results in a decision on which trajectory the vehicle should pursue. This approach takes into account a current status and potential costs resulting therefrom.

Another known solution is based on an exchange of data packets via, for example, Car2X. In this context, the vehicle and other road users exchange their planned trajectory bundles and jointly select the particular trajectories that, overall, generate the lowest cost in a common cost function. This enables an interaction between the vehicles but requires the use of Car2X in the involved vehicles and is therefore associated with additional costs.

### SUMMARY

A need exists to provide a method and a device for planning a future trajectory of an autonomously or semi-autonomously driving vehicle in which a social interaction can be better taken into account.

The need is addressed by a method and a device according to the independent claims. Some embodiments are apparent from the dependent claims, the following description, and the drawings.

### BRIEF DESCRIPTION OF THE DRAWINGS

FIG. 1 shows a schematic representation of an example embodiment of the device for planning a future trajectory of an autonomously or semi-autonomously driving vehicle; and

FIG. 2 shows a schematic representation of an example multi-agent reinforcement learning method to illustrate an embodiment of the method.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method is provided for planning a future trajectory of an automated or semiautomated driving vehicle, wherein sensor data are detected by means of at least one sensor of the vehicle, wherein an optimum trajectory for the vehicle is determined by means of a trajectory planning apparatus for an environmental status derived from the detected sensor data, wherein possible future trajectories of the vehicle are generated to this end and evaluated by means of a reward function, wherein in so doing, a behavior of the vehicle, a static environment and a behavior of other road users are taken into consideration, wherein an influence exerted by the behavior of the vehicle on the other road users is additionally taken into consideration in the reward function, and wherein the determined optimum trajectory is provided for execution.

Furthermore and in some embodiments, a device is created for planning a future trajectory of an autonomously or semi-autonomously driving vehicle, comprising a trajectory planning apparatus, wherein the trajectory planning apparatus is configured to determine an optimum trajectory for the vehicle for an environmental status derived from sensor data detected by at least one sensor of the vehicle and, to this end, to generate possible future trajectories of the vehicle and evaluate them by means of a reward function, wherein in so doing, a behavior of the vehicle, a static environment and a behavior of other road users are taken into consideration, wherein an influence exerted by the behavior of the vehicle on the other road users is additionally taken into consideration in the reward function, and wherein the determined optimum trajectory is provided for execution.

The method and the device make it possible to determine an optimum trajectory and, in so doing, to achieve an improved interaction with other road users without requiring direct communication with the other road users and an exchange of planned trajectories for this purpose. This is achieved in that, in a reward function used in trajectory planning (which, when the instantiation is reversed, can also be termed or used as a cost function), an influence exerted by the behavior of the vehicle on the other road users is taken into account. For example, at least one additional term can be provided in the reward function, by means of which the influence on the other road users is taken into account. In particular, the influence on the other road users is determined in that a plurality of alternative trajectories is generated, and the behavior of the other road users is estimated and evaluated as a particular reaction to these trajectories. The particular evaluation can be considered a measure of how high the costs (or the rewards) will be for the other road users when carrying out reactions to the alternative trajectories. If, for a trajectory of the vehicle considered by way of example, the costs of the reactions by other road users on alternative trajectories to the considered trajectory are high compared to the considered trajectory, the considered trajectory is beneficial because it only has less (or no) influence on the behavior of the other road users. Consequently, the considered trajectory achieves a higher value in the reward function (or a lower one in an analogously used cost function) due to the advantage for the other road users.

A benefit of the method and the device is that intrinsic social motivation can be taken into account when planning future trajectories of the vehicle. In particular, this enables cooperative behavior without requiring communication between the vehicle and the other road users. Taking into account the influence and the repercussions on another road users in assisted and autonomous driving functions also improves the driving experience.

The trajectory planning apparatus chooses in particular the trajectory as the optimum trajectory from the potential trajectories which achieves the maximum value determined by the reward function for a given environmental status.

An environmental status results in particular from the environment of the vehicle. The environmental status comprises in particular a static environment and a behavior of other road users, i.e., in particular a dynamic environment. The environment of the vehicle is in particular limited with respect to an extension around the vehicle. In particular, the environment can be restricted both with respect to a local extension as well as a number of other road users that are taken into account.

Parts of the device, in particular the trajectory planning apparatus, may be designed separately or collectively as a combination of hardware and software, for example as program code which is executed on a microcontroller or microprocessor. However, it is also possible for parts to be designed separately or collectively as an application-specific integrated circuit (ASIC).

It can alternately also be provided to use a cost function instead of a reward function. The method is then basically to be carried out analogously, wherein the instantiation of reward and cost are opposite.

Some embodiments provide that an influence exerted by the behavior of the vehicle on the other road users is estimated by means of an estimating apparatus, wherein to accomplish this, potential trajectories of the other road users are estimated and evaluated in each case depending on the possible future trajectories of the vehicle by means of at least one road user model. This allows other possible behaviors to be investigated depending on several possible trajectories of the vehicle and to be taken into account when determining the optimum trajectory. The evaluations received for the several possible trajectories are included in particular as an influence in the report function.

Some embodiments provide that the optimum trajectory is determined by means of a method of reinforcement learning, wherein the reward function used in this case has an influence term which describes an influence of actions of the vehicle on the actions of the other road users. This allows the vehicle to learn a behavior in steps where the influence of the behavior on the other road users is taken into account.

Reinforcement learning (also termed encouraging or reinforcing learning) is a machine learning method in which an agent independently learns a strategy to maximize received rewards. A reward can be both positive and negative in this case. By using the received rewards, the agent approximates a reward function that describes the value of a state or an action. In association with actions, such a value can also be termed an action value. Reinforcement learning methods consider in particular an interaction of the agent with his environment which is formulated in the form of a Markov decision problem. Starting from a given state, the agent can assume a different state by means of an action selected from one of several actions. Depending on the relevant decision, i.e., the performed action, the agent receives a reward. In so doing, the agent has the task of maximizing a profit anticipated in the future that consists of discounted rewards, i.e., the overall reward. At the end of the method, an approximated reward function stands for a given strategy with which a reward value or action value can be provided or estimated for each action.

An action can for example comprise the following activities for a vehicle: Straight-ahead driving with activated adaptive cruise control (ACC) (i.e., staying in the lane and not changing lanes), straight-ahead driving (no acceleration), straight-ahead driving and braking, changing lanes to the left lane or changing lanes to the right lane, etc.

A reward or an action value for an action in a state space can in particular take into account the following influences: avoiding a collision, staying on path (i.e., no or only a slight deviation from a path given by a navigation apparatus), time-optimized behavior, and/or comfort or utility for vehicle passengers. In addition, the influence of the action on other road users is also taken into account in accordance with the method.

In particular, the criteria that have an optimum trajectory can be adapted in this way to a current development or dynamic by the reinforcement learning method. The reward function then has in particular a term that contains the environment reward and at least another term, the influence term. In the influence term of the reward function, the influence of the behavior of the vehicle on the behavior of the other road users is taken into account. For example, it can be provided that the lesser an influence on the other road users for a considered trajectory or a considered action, the greater a share of the reward taken into account by the influence term. Conversely, the greater an influence on the other road users for a considered trajectory or a considered action, the smaller a share of the reward taken into account by the influence term. The relationship is therefore in particular inversely proportional. In this context, an action can comprise the entire trajectory or only a part of the trajectory, for example a path to the closest position of several positions on the trajectory. In the latter case, several sequentially performed actions then form a trajectory.

Some embodiments provide that the reinforcement learning method is configured as multi-agent reinforcement learning.

Some embodiments provide that at least part of the reinforcement learning method is executed on a backend server, wherein a reward function determined thereby is transmitted to the vehicle and is used there when determining the optimum trajectory. This allows, for example at least one initial or first training to be performed on a powerful backend server. It can also be provided that the initial or first training is at least partly carried out by means of a simulation, i.e., by means of a simulated environment, which can save costs and effort.

Some embodiments provide that several different road user types of the other road users are distinguished, wherein an influence exerted by the behavior of the vehicle on the other road users is taken into account depending on the road user type of the considered other road user. This allows differentiated behavior toward different other road users and therefore a different type of cooperation between the vehicle with the other road users. The different road user types can for example comprise one or more of the following: Passenger cars, trucks, cyclists or pedestrians. It can for example be provided that road users recognized in the environment are classified by means of a classification apparatus according to road user types, and each recognized road user type is assigned to the respective other road user type in the environment of the vehicle so that this can be accessed in further processing, in particular when estimating a behavior, i.e., in particular one or more trajectories, of the other road users.

Some embodiments provide that several different road user types of the other road users are distinguished, wherein each road user-dependent influence term is used in the reward function. This allows rewards for different road user types to be weighted differently, for example, and/or an influence on the reward to be taken into account individually in each case depending on the road user type.

Some embodiments provide that several different road user types of the other road users are distinguished, wherein road user type-dependent road user models are used in each case to estimate, by means of the estimating apparatus, an influence exerted by the behavior of the vehicle on the other road user. This allows the behavior of the other road users to be estimated depending on the road user type so that the behavior and an influence thereon can be taken into account in a differentiated manner.

Some embodiments provide that an influence exerted by the behavior of the vehicle on the other road users is or will be established depending on the derived environmental status. In this way, the instantiation of cooperation with other road users can be established depending on an environmental status of the vehicle derived from the currently detected sensor data.

Some embodiments provide that at least one situation is detected in the derived environmental status and/or in the detected sensor data by means of a situation detection apparatus, and an influence exerted by the behavior of the vehicle on the other road users is or will be established depending on the at least one detected situation. For example, the following situations can be distinguished and recognized: active or passive entering a highway, merging (e.g., zipper method), traffic circle, lane change, urban scenarios, etc. Depending on the situation, the influence of the behavior of the vehicle on the behavior of other road users can then be adapted. For example, a weighting of the influence, in particular in the reward function, can be adapted when determining the optimum trajectory. For example, the reward function for (multi-agent) reinforcement learning can be changed depending on the recognized situation, for example by adapting weighting factors. This allows for example cooperation with other road users in the “merging (zipper)” situation in the event of road narrowing to be greater than in a “lane change in multilane road traffic” situation in order to trigger cooperative behavior of the vehicle when merging.

Additional features of the device are apparent from the description of embodiments of the method. The benefits of the device in this context are in each case the same as of the method.

Furthermore, in some embodiments, a vehicle is provided, comprising at least one device according to any one of the embodiments described. The vehicle is in particular a motor vehicle. In principle, the vehicle can however also be another land vehicle, aircraft, watercraft, spacecraft or rail vehicle.

In the following, the invention is explained in greater detail based on various example embodiments and with reference to the FIGS. Specific references to components, process steps, and other elements are not intended to be limiting. Further, it is understood that like parts bear the same or similar reference numerals when referring to alternate FIGS.

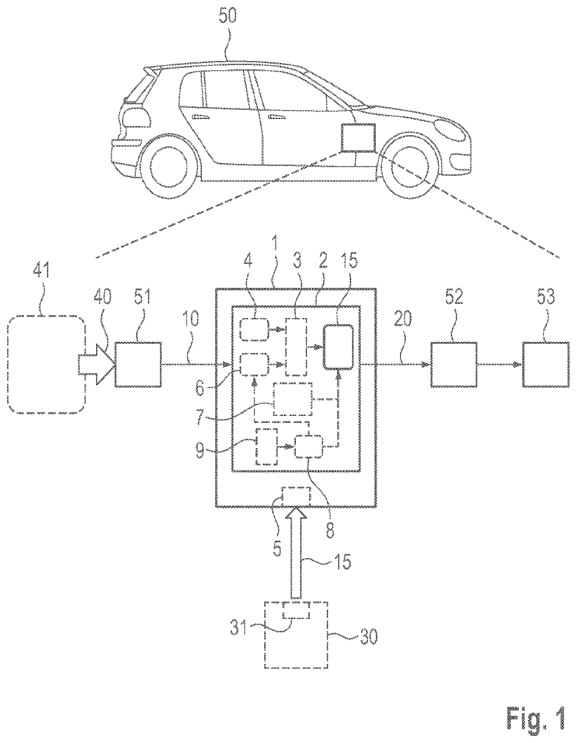

FIG. 1 shows a schematic representation of an embodiment of the device 1 for planning a future trajectory of an autonomously or semi-autonomously driving vehicle 50. The device 1 performs in particular the method described in this disclosure.

The device 1 comprises a trajectory planning apparatus 2. The trajectory planning apparatus 2 is configured to determine an optimum trajectory 20 for the vehicle 50 for an environmental status 40 that was derived from sensor data 10 detected by means of at least one sensor 51 of the vehicle 50. The at least one sensor 51 can for example be a camera, a lidar sensor, a radar sensor, or an ultrasonic sensor, etc. that detects a current environment 41 of the vehicle 50. The determined optimum trajectory 20 is then provided for execution and, for this purpose, is supplied in particular to a control device 52 of the vehicle 50 which controls an actuator system 53 of the vehicle 50 so that the optimum trajectory 20 is executed.

The method is repeated, in particular cyclically, so that a current optimum trajectory 20 can always be provided.

Parts of the device 1, in particular the trajectory planning apparatus 2, may be designed individually or assembled as a combination of hardware and software, for example as program code that is run on a microcontroller or a microprocessor.

To determine the optimum trajectory 20, the trajectory planning apparatus 2 generates possible future trajectories of the vehicle 50 in the environment and evaluates the generated possible future trajectories by means of a reward function 15, wherein a behavior of the vehicle 50, a static environment, and the behavior of other road users are taken into account.

In addition, an influence exerted by the behavior of the vehicle 50 on the other road users is taken into account in the reward function 15.

In doing so, it is provided in particular that cooperative behavior with other road users is rewarded, and uncooperative behavior is penalized. Rewarding and penalizing is carried out using a correspondingly configured reward function 15.

It can be provided that the device 1, in particular the trajectory planning apparatus 2, comprises an estimating apparatus 3. It is then provided that an influence exerted by the behavior of the vehicle 50 on the other road users is estimated by means of the estimating apparatus 3, wherein possible trajectories of the other road users are estimated and evaluated for this purpose depending on the possible future trajectories of the vehicle 50 in each case by means of at least one road user model 4. The influence is taken into account in the reward function 15.

It can be provided that the optimum trajectory 20 is determined by means of a reinforcement learning method, wherein the reward function 15 used in this context has an influence term which describes an influence of actions of the vehicle 50 on actions of the other road users.

In some embodiments, the reinforcement learning method is configured as multi-agent reinforcement learning.

It can be provided that at least part of the reinforcement learning method is executed on a backend server 30, wherein a reward function 15 determined thereby is transmitted to the vehicle 50 and is used there when determining the optimum trajectory 20. The determined reward function 15 is for example transmitted via communication interfaces 5, 31 of the device 1 and the backend server 30.

It can be provided that several different road user types 8 of the other road users are distinguished, wherein an influence exerted by the behavior of the vehicle 50 on the other road users is taken into account in each case depending on the road user type 8 of the considered other road user. To determine the road user type 8, a classification apparatus 9 can for example be provided that classifies the other road users in the environment 40 of the vehicle 50 on the basis of the environmental status 40 or the detected sensor data 10, for example according to the following road user types 9: Passenger cars, trucks, cyclists, pedestrians (adult), pedestrians (child), etc. The determined road user type 8 is also taken into account in the reward function 15.

It can in particular be provided that road user-dependent influence terms are in each case used in the reward function 15. For example, coefficients in the influence term can be selected and/or adapted depending on the road user type 8 determined in the environment for another road user.

It may be provided that road user type-dependent road user models 6 are used in each case to estimate, by means of the estimation device 3, an influence exerted by the behavior of the vehicle 50 on the other road users.

It may be provided that an influence exerted by the behavior of the vehicle 50 on the other road users is or will be established depending on the derived environmental status 40.

It may be provided that the device 1 has a situation recognition apparatus 7. At least one situation is detected in the derived environmental status 40 and/or in the detected sensor data 10 by means of the situation detection apparatus 7, and an influence exerted by the behavior of the vehicle 50 on the other road users is established depending on the at least one detected situation. This allows strength of cooperation to be increased depending on a recognized situation (such as merging in front of a construction site, changing lanes in the city, passing oncoming traffic in road narrowings, etc.).

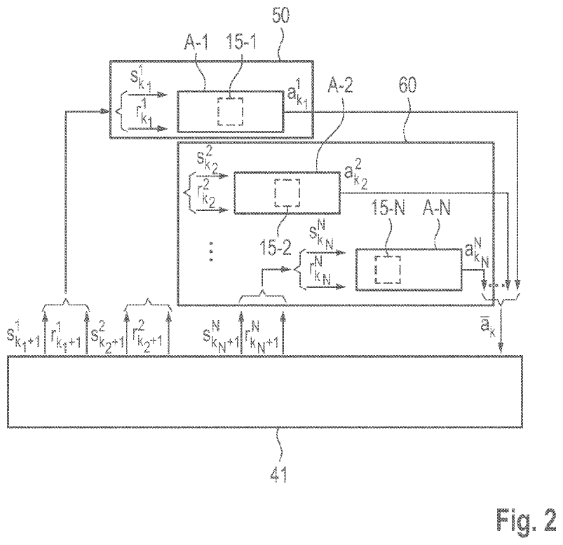

FIG. 2 shows a schematic representation of a multi-agent reinforcement learning method to illustrate an embodiment of the method.

In multi-agent reinforcement learning (also referred to as encouraging or reinforcing learning), multiple agents A-x independently learn a strategy to maximize received rewards r^{x}ₖₓ (where x is an index running to N for the agents, and kx denotes a time step considered in each case for an agent x, with e.g. kx=0, 1, 2, . . . ). A reward can be both positive and negative in this case. By using the received rewards, agent A-x approximates (in each case) a reward function 15-x that describes what value a state s^{x}ₖₓ or an action a^{x}ₖₓ has. In association with actions, such a value can also be termed an action value.

Reinforcement learning methods consider in particular an interaction of the agent A-x with an environment 41 or surroundings that is formulated in the form of a Markov decision problem (MDP). The agent A-x can pass from a state s^{x}ₖₓ given at a time step kx to another state s^{x}ₖₓ+1 by an action a^{x}ₖₓ selected from several actions. Depending on the made decision, i.e. the executed action a^{x}ₖₓ, the agent A-x receives a reward r^{x}ₖₓ. In particular, each agent A-x has the task of maximizing a future expected profit which consists of discounted rewards r^{x}ₖₓ, i.e. the total reward. At the end of the method, there is an approximated reward function 15-x for a given policy with which a reward value r^{x}ₖₓ (or action value) can be provided or estimated for each action a^{x}ₖₓ. Using the reward function 15-x, in particular those actions that form or contain the optimum trajectory can be determined.

In multi-agent reinforcement learning, each of the plurality of agents A-x learns a reward function 15-x, wherein the agents A-x perform their respective actions a^{x}ₖₓ in the same environment 41.

The vehicle 50 is, for example, the agent A-1, and the other road users 60 are, for example, the agents A-2 to A-N, wherein it can also be provided that other road users 60 do not themselves determine or learn their respective optimum trajectories by reinforcement learning. Accordingly, other road users can also be, for example, pedestrians, cyclists and/or manually controlled vehicles. These are then taken into account in particular as part of the environment 41 in the respective (environmental) states s^{x}ₖₓ.

The reward functions 15-x used by the agents A-x in multi-agent reinforcement learning have influence terms that describe an influence of actions a^{x}ₖₓ of the vehicle 50 on actions a^{x}ₖₓ of the other road users 60. In particular, a positive reward for an action a^{x}ₖₓ covered by an influence term is smaller the greater an influence on the other road users 60 caused by the action a^{x}ₖₓ. Conversely, a positive reward covered by the influence term can be greater the smaller an influence on the other road users 60 caused by the action a^{x}ₖₓ. This allows cooperative behavior to be promoted without exchanging planned trajectories.

It may be provided that at least part of the multi-agent reinforcement learning method is executed on a backend server, wherein a reward function 15-x determined thereby is transmitted to the vehicle 50 and is used there when determining the optimum trajectory. Certain reward functions 15-x can also be transmitted to the other road users 60 on the backend server.

### LIST OF REFERENCE NUMERALS

1 Device
2 Trajectory planning apparatus
3 Estimating apparatus
4 Road user model
5 Communication interface
6 Road user model
7 Situation recognition apparatus
8 Road user type
9 Classification apparatus
10 Sensor data
15, 15-x Reward function
20 Optimum trajectory
30 Backend server
31 Communication interface
40 Environmental status
41 Surroundings
50 Vehicle
51 Sensor
52 Control apparatus
53 Actuator system
60 Other road user
A-x Agent
s^{x}ₖₓ (Environmental) status of agent x in time step kx
a^{x}ₖₓ Action of agent x in time step kx
r^{x}ₖₓ (Environmental) status of agent x in time step kx

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for planning a future trajectory of an autonomously or semi-autonomously driving vehicle, comprising:
detecting sensor data using at least one sensor of the vehicle;
an optimum trajectory for the vehicle for an environmental status derived from the detected sensor data, comprising generating and evaluating possible future trajectories of the vehicle using a reward function behavior and using data on a behavior of the vehicle, a static environment, and a behavior of other road users,
wherein an influence exerted on the other road users by the behavior of the vehicle is taken into consideration in the reward function; and
providing the determined optimum trajectory for execution.

2. The method of claim 1, comprising estimating the influence exerted by the behavior of the vehicle on the other road users, comprising estimating and evaluating possible trajectories of the other road users depending on the possible future trajectories of the vehicle using at least one road user model.

3. The method of claim 1, comprising determining the optimum trajectory using a reinforcement learning method, wherein the reward function has an influence term which describes an influence of actions of the vehicle on actions of the other road users.

4. The method claim 3, wherein at least part of the reinforcement learning method is executed on a backend server, wherein a reward function determined thereby is transmitted to the vehicle and is use by the vehicle when determining the optimum trajectory.

5. The method of claim 1, comprising distinguishing different road user types of the other road users, wherein the influence exerted by the behavior of the vehicle on the other road users is taken into consideration depending on the road user type of the considered other road user.

6. The method of claim 1, comprising distinguishing several different road user types of the other road users, wherein road user type-dependent road user models are used to estimate an influence exerted by the behavior of the vehicle on the other road users.

7. The method of claim 1, comprising establishing an influence exerted by the behavior of the vehicle on the other road users depending on the derived environmental status.

8. The method of claim 1, comprising detecting at least one situation in the derived environmental status and/or in the detected sensor data and establishing an influence exerted by the behavior of the vehicle on the other road users depending on the at least one detected situation.

9. A device for planning a future trajectory of an autonomously or semi-autonomously driving vehicle, comprising:
a trajectory planning apparatus, wherein the trajectory planning apparatus is configured to:
determine an optimum trajectory for the vehicle for an environmental status derived from sensor data detected by at least one sensor of the vehicle; and to
generate possible future trajectories of the vehicle and evaluate the possible future trajectories using a reward function, wherein a behavior of the vehicle, a static environment, and a behavior of other road users are taken into consideration, and wherein an influence exerted by the behavior of the vehicle on the other road users is additionally taken into consideration in the reward function; wherein
the trajectory planning apparatus is configured to provide the determined optimum trajectory for execution.

10. A vehicle comprising at least one device according to claim 9.

11. The method of claim 2, comprising determining the optimum trajectory using a reinforcement learning method, wherein the reward function has an influence term which describes an influence of actions of the vehicle on actions of the other road users.

12. The method of claim 11, wherein at least part of the reinforcement learning method is executed on a backend server, wherein a reward function determined thereby is transmitted to the vehicle and is used by the vehicle when determining the optimum trajectory.

13. The method of claim 2, comprising distinguishing different road user types of the other road users, wherein the influence exerted by the behavior of the vehicle on the other road users is taken into consideration depending on the road user type of the considered other road user.

14. The method of claim 3, comprising distinguishing different road user types of the other road users, wherein the influence exerted by the behavior of the vehicle on the other road users is taken into consideration depending on the road user type of the considered other road user.

15. The method of claim 4, comprising distinguishing different road user types of the other road users, wherein the influence exerted by the behavior of the vehicle on the other road users is taken into consideration depending on the road user type of the considered other road user.

16. The method of claim 2, comprising distinguishing several different road user types of the other road users, wherein road user type-dependent road user models are used to estimate an influence exerted by the behavior of the vehicle on the other road users.

17. The method of claim 3, comprising distinguishing several different road user types of the other road users, wherein road user type-dependent road user models are used to estimate an influence exerted by the behavior of the vehicle on the other road users.

18. The method of claim 4, comprising distinguishing several different road user types of the other road users, wherein road user type-dependent road user models are used to estimate an influence exerted by the behavior of the vehicle on the other road users.

19. The method of claim 5, comprising distinguishing several different road user types of the other road users, wherein road user type-dependent road user models are used to estimate an influence exerted by the behavior of the vehicle on the other road users.

20. The method of claim 2, comprising establishing an influence exerted by the behavior of the vehicle on the other road users depending on the derived environmental status.
